(19) United States
(12) Patent Application Publication
(10) Pub. No.: US 2023/0039527 A1
(43) Pub. Date: Feb. 9, 2023

(54) CATHODE AND ELECTROLYTE CHEMISTRY FOR SCALABLE ZINC ION BATTERY

(71) Applicant: KING ABDULLAH UNIVERSITY OF SCIENCE AND TECHNOLOGY, Thuwal (SA)

(72) Inventors: Yunpei ZHU, Thuwal (SA); Husam Niman ALSHAREEF, Garland, TX (US)

(21) Appl. No.: 17/791,741

(22) PCT Filed: Jan. 20, 2021
(86) PCT No.: PCT/IB2021/050427

§ 371 Date: Jul. 8, 2022

Related U.S. Application Data
(60) Provisional application No. 62/972,235, filed on Feb. 10, 2020.
(60) Provisional application No. 63/046,116, filed on Jun. 30, 2020.

(51) Int. Cl. H01M 10/38; C01G 31/00; H01M 10/0569; H01M 50/40

(52) U.S. Cl. CPC H01M 10/38; C01G 31/00; H01M 10/0569; H01M 50/40; H01M 2300/0002; C01P 2004/16; C01P 2006/40

(57) ABSTRACT

A zinc ion battery includes a cathode; an anode; a separator; and an electrolyte sandwiched between the cathode and the anode. The electrolyte includes a mixture of zinc perchlorate and sodium perchlorate, and a ratio of the sodium perchlorate to zinc perchlorate is at least 30.

### CROSS-REFERENCE TO RELATED APPLICATIONS

This application claims priority to U.S. Provisional Patent Application No. 62/972,235, filed on Feb. 10, 2020, entitled “NEW CATHODE AND ELECTROLYTE CHEMISTRY FOR SCALABLE ZINC ION BATTERIES,” and U.S. Provisional Patent Application No. 63/046,116, filed on Jun. 30, 2020, entitled “CATHODE AND ELECTROLYTE CHEMISTRY FOR SCALABLE ZINC ION BATTERY,” the disclosures of which are incorporated herein by reference in their entirety.

### BACKGROUND

### Technical Field

Embodiments of the subject matter disclosed herein generally relate to a cathode and electrolyte for a metal ion battery, and more particularly, to a vanadium based cathode used in conjunction with a highly concentrated zinc perchlorate electrolyte in a zinc ion battery.

### Discussion of the Background

Lithium-ion batteries (LIB) have been playing an increasingly vital role in hand-held electronics, electric vehicles, and energy storage in the past decades. Considering the limited lithium supplies present in earth's crust (20 ppm), and the growing need for large-scale renewable energy storage, there is a desire to develop alternative rechargeable battery chemistries based on more earth-abundant elements, such as zinc.

Compared to the lithium metal, the zinc shows a higher volumetric capacity of 5,855 mAh cm⁻³ (lithium: 2,061 mAh cm⁻³), is nontoxic and its handling does not pose any safety risk, making the zinc ion batteries (ZIBs) promising for the grid-scale application. Typically, rechargeable ZIBs include cathodes for Zn²⁺ (de)intercalation, aqueous electrolytes in majority, and zinc metal anodes. However, the ZIBs reported in the literature still cannot satisfy the requirements for practical applications due to the insufficient stabilities of both the cathodes and anodes, fast self-discharging, and an energy-consuming cathode production with low yield. Developing new and scalable chemical strategies for cathodes and electrolytes would make the aqueous ZIBs more appealing for industrial manufacturing and wide use.

Conventional aqueous electrolytes, including Zn(CF₃SO₃)₂, Zn(ClO₄)₂, and ZnSO₄, can ensure the reversible Zn plating/stripping with a high efficiency, but the life cycle of the cathode materials fades fast per cycle, especially at a low current density, which mainly results from the dissolution of the cathode materials into these classical electrolytes. In this regard, FIG. 1A shows the capacity retention of the cathode material for the Zn(CF₃SO₃)₂ electrolyte, FIG. 1B shows the same capacity retention of the cathode material for the Zn(ClO₄)₂ electrolyte, and FIG. 1C shows the capacity retention of the cathode material for the ZnSO₄ electrolyte. Each of these figures show that the capacity retention of the cathode dramatically decreases to less than 30% after about 100 cycles, which is unacceptable for a reliable metal ion battery.

Thus, there is a need for a new cathode material and electrolyte composition that overcome these problems, is easy to scale up for industrial production, and make use of widely available materials.

### BRIEF SUMMARY OF THE INVENTION

According to an embodiment, there is a zinc ion battery that includes a cathode, an anode, a separator, and an electrolyte sandwiched between the cathode and the anode. The electrolyte includes a mixture of zinc perchlorate and sodium perchlorate, and a ratio of the sodium perchlorate to zinc perchlorate is at least 30.

According to another embodiment, there is a combination of a cathode and an electrolyte for a zinc ion battery, and the combination includes the cathode including nanowires, and the electrolyte including a mixture of zinc perchlorate and sodium perchlorate. A ratio of the sodium perchlorate to the zinc perchlorate is at least 30.

According to still another embodiment, there is a method of manufacturing a zinc ion battery that includes making an aqueous electrolyte that includes a mixture of zinc perchlorate and sodium perchlorate; making a cathode that includes nanowires; sandwiching the electrolyte between the cathode and an anode; placing a separator between the cathode and the anode; and placing the cathode, the anode, the separator, and the electrolyte inside a casing. A ratio of the sodium perchlorate to the zinc perchlorate is at least 30.

### BRIEF DESCRIPTION OF THE DRAWINGS

For a more complete understanding of the present invention, reference is now made to the following descriptions taken in conjunction with the accompanying drawings, in which:

FIGS. 1A to 1C illustrate the capacity retention of a cathode material versus a cycle number in various metal ion batteries;

FIG. 2 illustrates the capacity retention of a novel cathode material when used with a novel electrolyte for a zinc ion battery;

FIG. 3 illustrates the capacity retention versus a cycle number for various concentrations of the novel electrolyte of the zinc ion battery;

FIG. 4 illustrates a comparison between the Raman shift of pure water, two traditional electrolytes, and the novel electrolyte;

FIG. 5 illustrates a comparison between the chemical shift of pure water, two traditional electrolytes, and the novel electrolyte;

FIG. 6A illustrates the galvanostatic zinc stripping/platting in a Zn/Zn symmetrical cell using the novel electrolyte, and FIG. 6B compares the Zn stripping/plating curves of the novel electrolyte with two traditional electrolytes;

FIG. 7A shows the XRD pattern of a novel nanowire cathode, FIG. 7B illustrates the scanning electronic microscopy image of the novel nanowire cathode, and FIG. 7C illustrates the transmission electron microscopy image of the nanowire cathode;

FIG. 8 illustrates a zinc ion battery that uses a novel combination of a highly-concentrated electrolyte and a vanadium based cathode;

FIG. 9 shows the rate performance for the vanadium based electrode of the novel battery;

FIG. 10 shows the long-term cycling performance of the vanadium based electrode of the novel battery;

FIG. 11A shows the storage performance of the novel zinc ion battery after resting for 24 h, FIG. 11B shows the storage performance of a traditional zinc ion battery that uses a first known electrolyte, and FIG. 11C shows the storage performance of a traditional zinc ion battery that uses a second known electrolyte; and

FIG. 12 is a flowchart of a method for manufacturing a zinc ion battery having a novel combination of a cathode material and aqueous electrolyte.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a novel electrolyte that includes zinc perchlorate and sodium perchlorate. However, the embodiments to be discussed next are not limited to zinc perchlorate, but may be applied to other zinc salts.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, an aqueous electrolyte and scalable production of cathode materials for highly efficient zinc-ion batteries are developed. The newly designed electrolyte can facilitate the reversible and stable zinc plating and stripping with high Coulombic efficiency. In addition, Zn²⁺ can be reversible intercalated/deintercalated into/from the vanadium-oxide-based cathode, showing a large capacity and an extremely high stability.

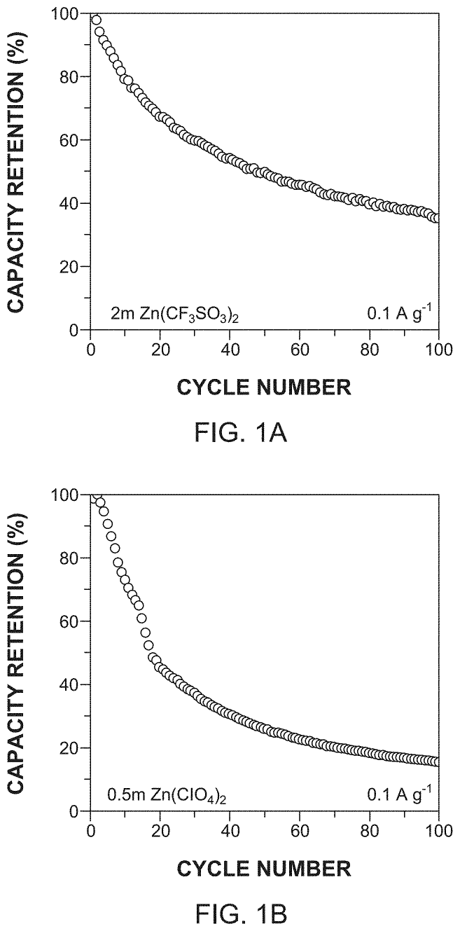

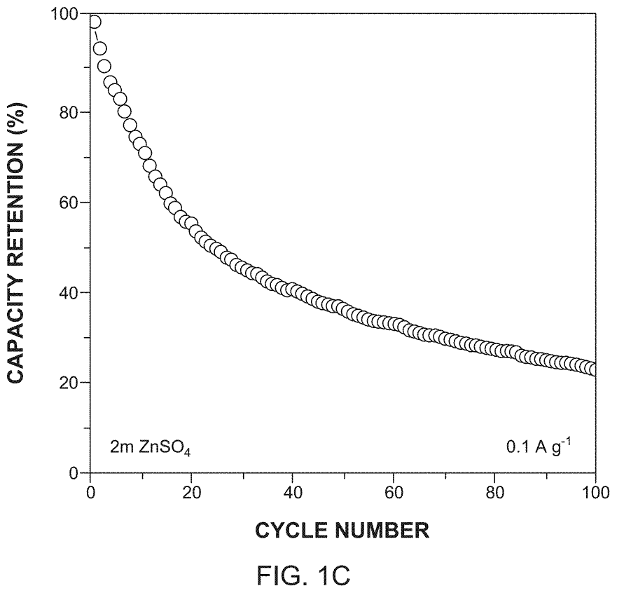

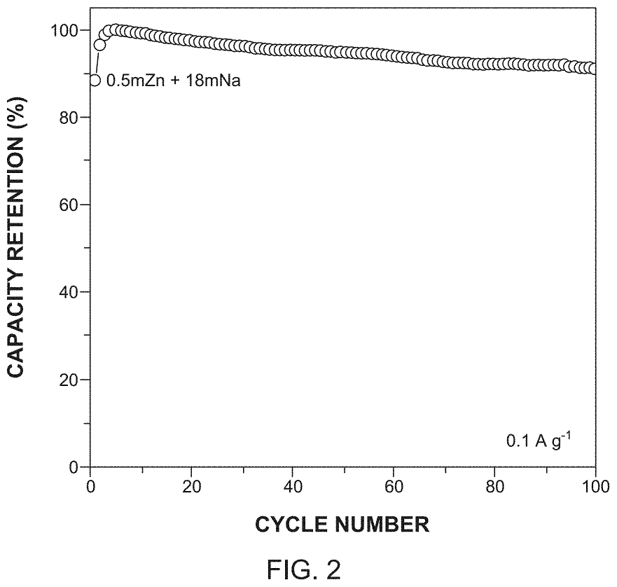

In one embodiment, a highly-concentrated aqueous electrolyte for use in the ZIB is introduced. The highly-concentrated aqueous electrolyte includes 0.5 m zinc salt and 18 m NaClO₄ (in a water solution), where “m” is the molality, which is measured in mol kg⁻¹. The molality of a solution is defined as the amount (in moles) of the solute divided by the mass (in kg) of the solvent. In one embodiment, the molality for the zinc salt is between 0.25 and 0.75 and the molality for the sodium perchlorate is between 16 and 18. Such a highly-concentrated aqueous electrolyte leads to a remarkably increased stability of the cathode material as illustrated in FIG. 2. When comparing the capacity retention of the cathode material after 100 cycles, FIG. 2 shows that it went down to about 90% for the novel highly-concentrated aqueous solution, while for the traditional aqueous solutions discussed above with regard to FIGS. 1A to 1C, the capacity retention went down to 30% or less, as noted in FIGS. 1A to 1C. This stability enhancement provided by the highly-concentrated aqueous electrolyte can be strongly related to the depression of the cathode dissolution.

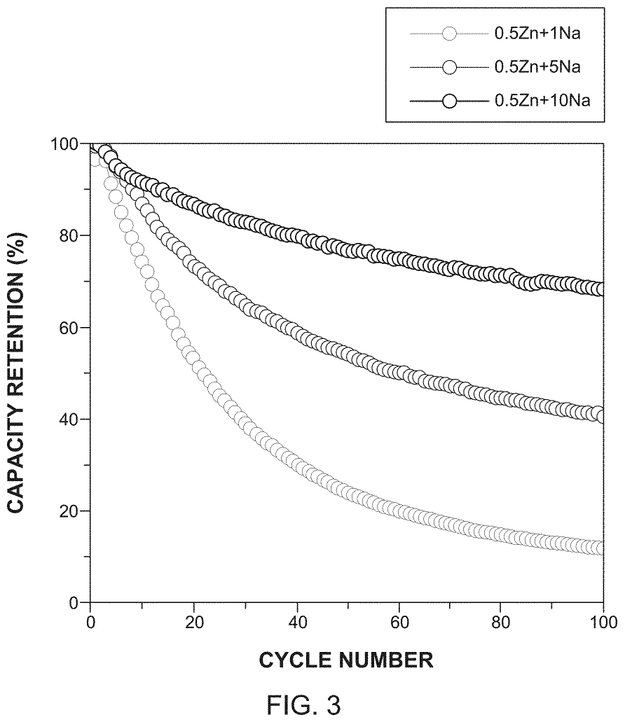

Zinc salts that can be used in this highly-concentrated aqueous electrolyte can include Zn(ClO₄)₂, Zn(CF₃SO₃)₂, Zn(NO₃)₂, ZnSO₄, or ZnCl₂. In this embodiment, the electrolyte composed of 0.5 m Zn(ClO₄)₂ and 18 m NaClO₄ is just an example and those skilled in the art would understand that any of the zinc salts noted above can be used. In addition, the amount of the zinc salt can be increased up to 1 m while the amount of sodium perchlorate can vary between 15 and 20 m. For a given vanadium based cathode material (e.g., Na₂V₆O₁₆, which is discussed later in more detail), other electrolytes with different NaClO₄ concentrations were tested for determining the stability of the electrode. As illustrated in FIG. 3, the higher the concentration of the sodium perchlorate in the electrolyte solution, the higher the cycling stability of the electrode. FIG. 3 shows the capacity retention of the vanadium based cathode for various concentrations of the sodium perchlorate.

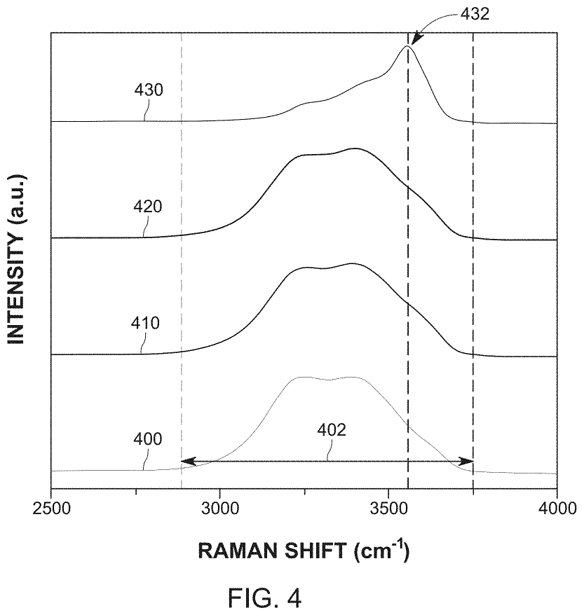

The aqueous electrolyte has been studied with Raman and ¹⁷O Nuclear Magnetic Resonance (NMR) for understanding the behavior of the water molecules and their interaction with the cathode material. For pure water 400, a wide Raman band 402 with several components appears as illustrated in FIG. 4. This is the result of the interaction of different water molecules with various O—H bonds in the water clusters. For the dilute solution 410 of 0.5 m ZnClO₄ and the dilute solution 420 of 1 m NaClO₄, their intensity still show similar Raman characteristic peaks to that of the pure water 400, indicating the presence of a large amount of free water clusters. In sharp contrast, the typical Raman signals of water clusters in the highly concentrated electrolyte 430 (0.5 m Zn(ClO₄)₂ and 18 m NaClO₄) disappear, along with the generation of a new sharp peak 432 at 3550 cm⁻¹. This suggests that the free water clusters are significantly diminished in the highly-concentrated electrolyte 430.

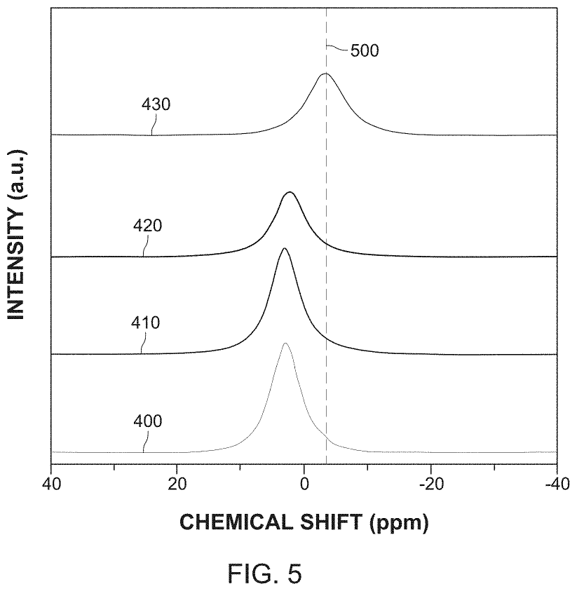

The NMR spectra for the solutions illustrated in FIG. 4 were generated and plotted in FIG. 5, and they reveal the coordination between the water molecules and the salt ions. Compared to the pure water 400, the 0.5 m Zn(ClO₄)₂ solution 410, and the 1 m NaClO₄ solution 420, the ¹⁷O signal 500 of the highly-concentrated electrolyte 0.5 m Zn(ClO₄)₂ and 18 m NaClO₄ 430 downshifts. This phenomenon is related to the fact that the lone-pair electrons from the O atoms in water can be depleted by the Na⁺ cations, leading to the deshielding effect of the O nucleus.

Thus, according to the Raman and NMR spectra illustrated in FIGS. 4 and 5, the inventors have confirmed that for the highly-concentrated electrolyte 430, the majority of the water molecules have been confined within the Na⁺ solvation structures. This significantly decreases the amount of free water clusters, thus prohibiting the dissolution of the cathode materials in the aqueous ZIBs.

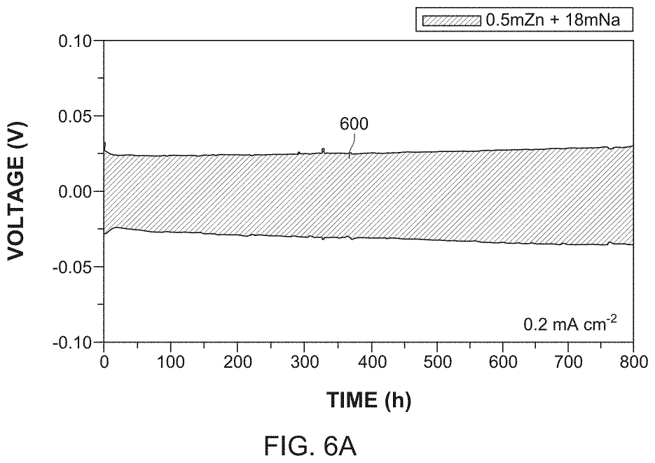

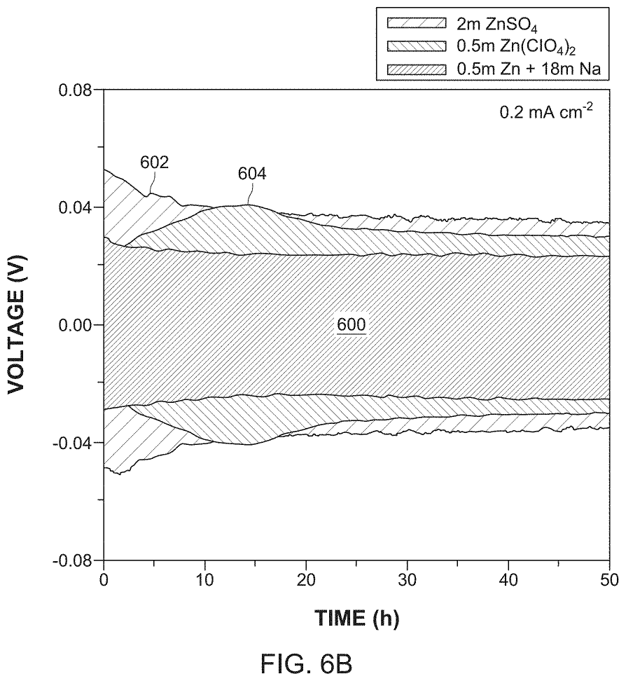

The stability and reversibility of the Zn anode in the highly-concentrated electrolyte 430 were studied using a Zn/Zn symmetric cell at a constant current density. After 800 h of continuous operation, the Zn/Zn cell can be durably cycled without an obvious increase of overpotentials, as illustrated by the Zn stripping/plating curve 600 in FIG. 6A. FIG. 6A illustrates the galvanostatic Zn stripping/platting in the Zn/Zn symmetrical cell at 0.2 mA cm⁻². Compared to the Zn stripping/platting curves 602 and 604 of the conventional electrolytes of ZnSO₄ and Zn(ClO₄)₂, respectively, which are illustrated in FIG. 6B, the Zn stripping/platting curve 600 of the Zn/Zn symmetric cell utilizing the highly-concentrated electrolyte 430 exhibits smaller voltage hysteresis between deposition and dissolution, which is an indicator of more facile electrode kinetics.

The highly-concentrated electrolyte 430 was developed by the inventors to work in synergism with a cathode material. Traditionally, the synthesis of the cathode materials for the ZIBs involves energy-/time-consuming and complicated techniques, such as the hydrothermal method and electrodeposition, making them difficult to scale up for practical applications and industrial productions. To solve this problem, the inventors developed a scalable, facile reconstruction method to synthesize Na₂V₆O₁₆ nanowires at room temperature, starting with commercially available, low-price V₂O₅ and NaCl components. The Na₂V₆O₁₆ nanowires are used to form the cathode.

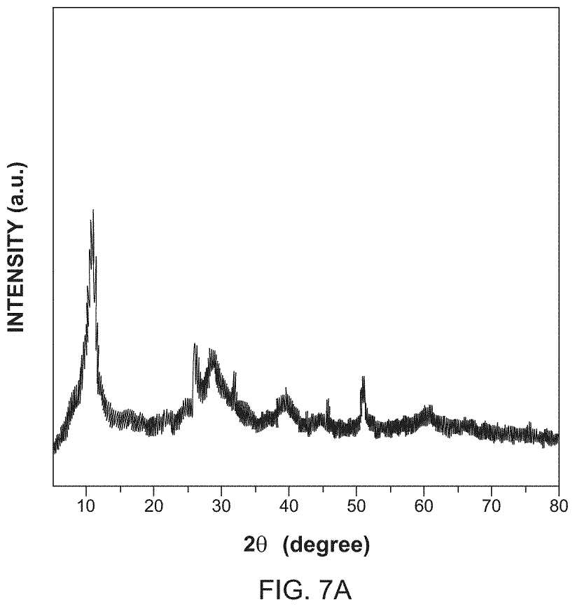

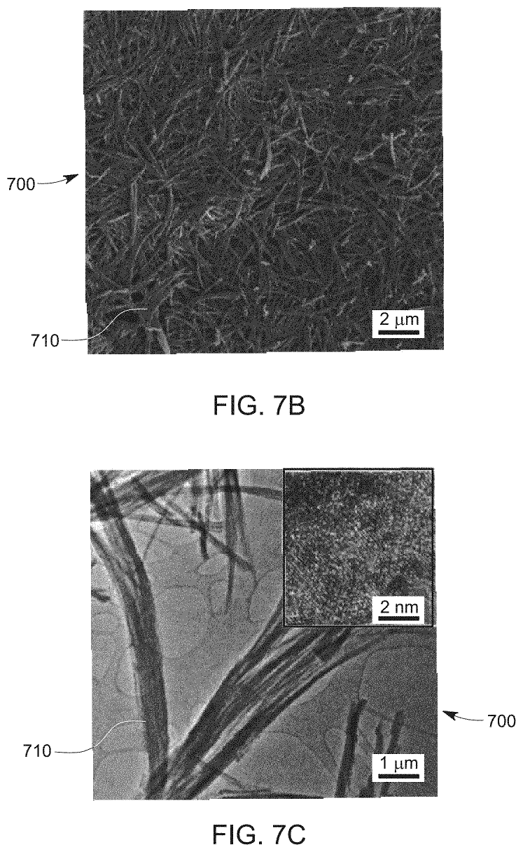

In one application, the inventors have synthesized 100 g Na₂V₆O₁₆ after reacting 100 g V₂O₅ powder with 100 mL of 3M NaCl (M: mol L⁻¹) for 2 days using a 1 L reactor, where the NaCl used during the synthesis of the Na₂V₆O₁₆ could be replaced by other sodium salts like NaNO₃, Na₂SO₄, and NaClO₄. After the chemical reaction, a red product was collected by filtration, washed with water, and dried in an electric oven. The X-ray diffraction (XRD) pattern shows in FIG. 7A illustrates the monoclinic phase for the synthesized Na₂V₆O₁₆ (space group: P₂₁/m), while the scanning electron transmission (SEM) image in FIG. 7B and the transmission electron microscopy (TEM) image in FIG. 7C show the well-defined nanowires 710 of the novel cathode 700 and the nanowires have a relatively uniform diameter distribution.

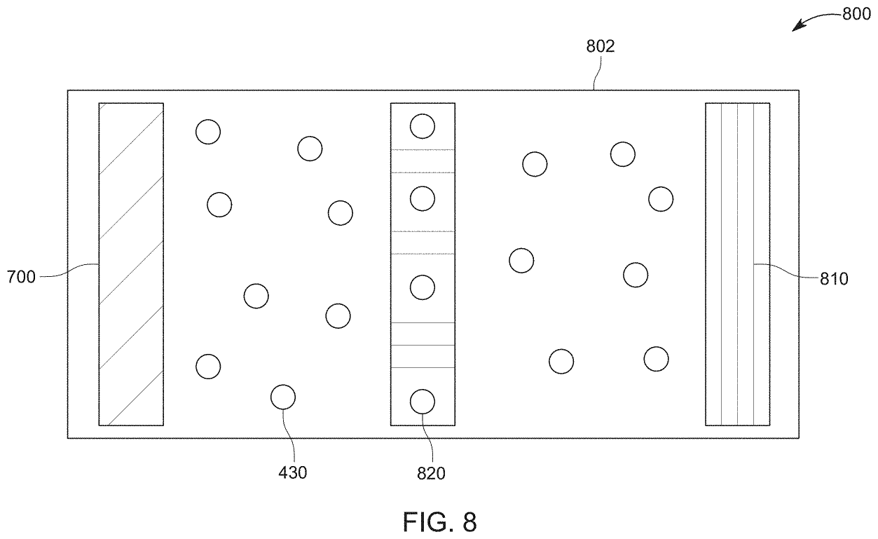

To prepare the novel cathode 700, the synthesized Na₂V₆O₁₆ nanowires were mixed in one embodiment with commercial conductive carbon and poly binder, like polyvinylidene difluoride, and then the mixture was made into a slurry using N-methyl-2-pyrrolidone as the solvent. The slurry was casted onto a titanium foil using a doctor blading method and dried at 80° C. for 12 h in a vacuum oven. This cathode 700 was assembled into a battery 800 (i.e., Zn/Na₂V₆O₁₆), as illustrated in FIG. 8, using a Zn anode 810 and the high-concentration electrolyte 430 (0.5 m Zn(ClO₄)₂+18 m NaClO₄). A separator 820 may be placed between the cathode 700 and the anode 810 and all these elements may be placed inside a casing 802. In one embodiment, the electrolyte 430 includes a mixture of zinc perchlorate and sodium perchlorate, and a ratio of the sodium perchlorate to zinc perchlorate is at least 30. In another embodiment, the ratio of the sodium perchlorate to zinc perchlorate is 36. Other numbers may be used for this ratio.

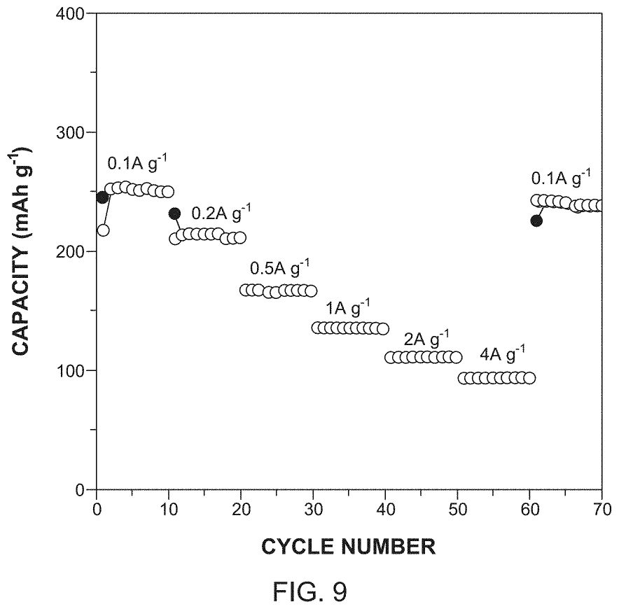

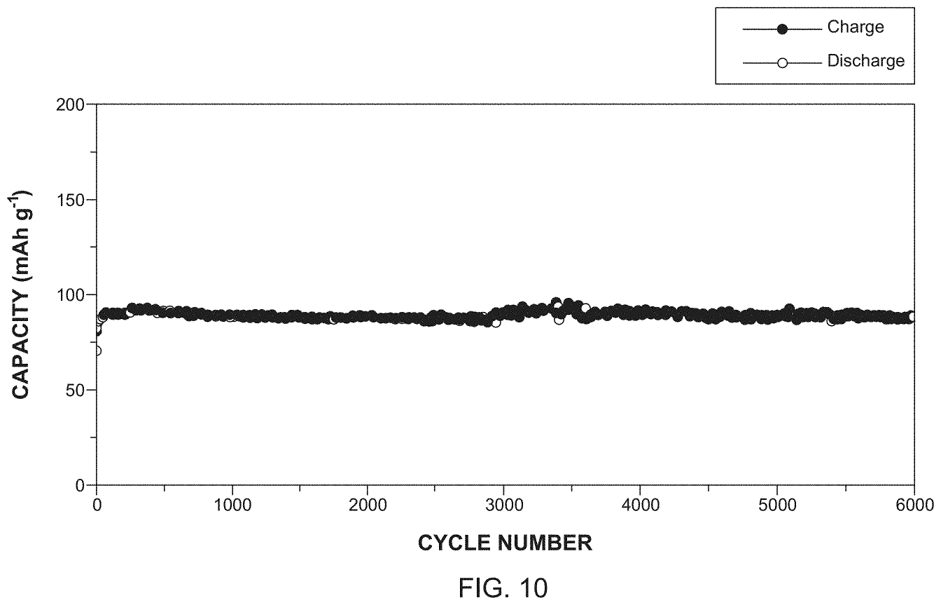

The Na₂V₆O₁₆ electrode 700 can deliver a good rate capability for various current densities, as illustrated in FIG. 9. The Na₂V₆O₁₆ electrode 700 exhibits average discharge capacities of 250, 210, 165, 134, 110, and 94 mAh g⁻¹ at current densities of 0.1, 0.2, 0.5, 1, 2, and 4 A g⁻¹, respectively. Upon reversing to the current density of 0.1 A g⁻¹, a high specific capacity of 238 mAh g⁻¹ can be obtained, revealing the stability and capability of the novel Na₂V₆O₁₆ electrode 700 to withstand large-current charges and discharges. More importantly, the Na₂V₆O₁₆ electrode 700 can maintain its discharge capacity even after 6000 cycles at 4 A g⁻¹ with a Coulombic efficiency (CE) close to 100% as illustrated in FIG. 10.

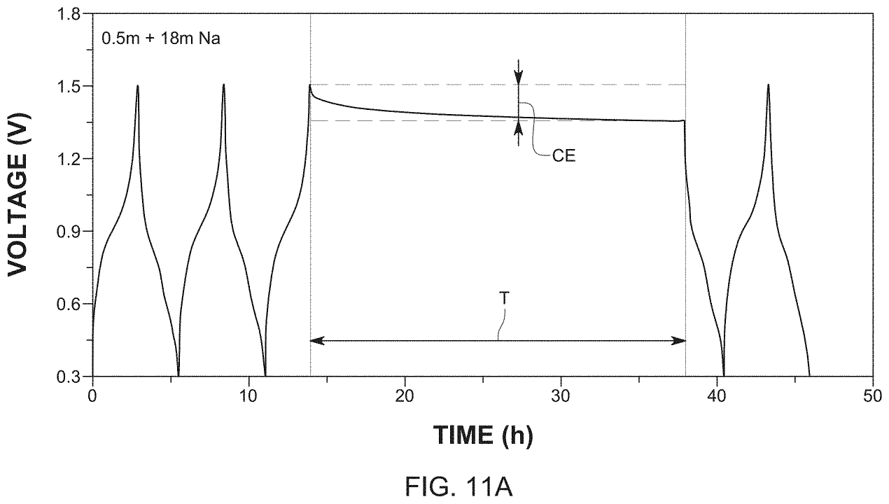

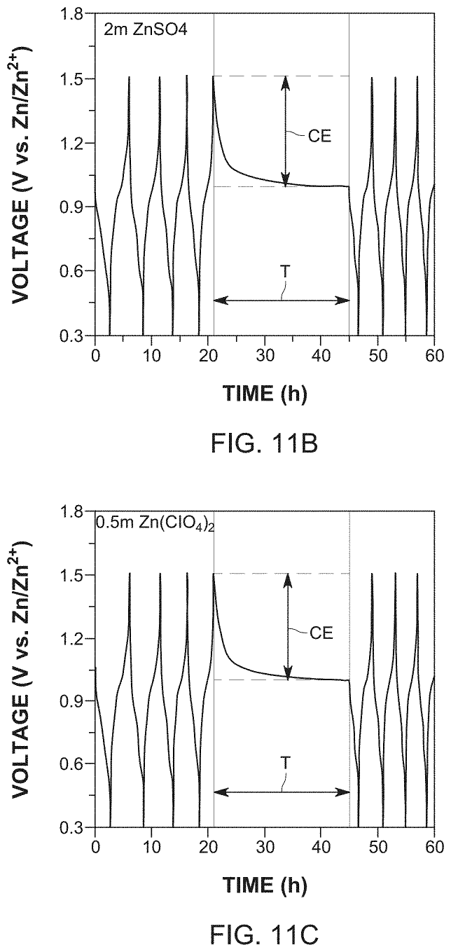

The parasitic reactions in the Zn/Na₂V₆O₁₆ battery 800 were evaluated by monitoring the open circuit voltage of the battery at a fully charged state and then discharging it after resting for a time T, which is 24 hours in this case. FIG. 11A, which plots the voltage of the battery versus time, show that 98.5% of the initial capacity of the battery 800 having the 0.5 m Zn(ClO₄)₂+18 m NaClO₄ electrolyte can be retained (i.e., the columbic efficiency CE is 98.5%), while two other batteries using the conventional electrolytes show a much faster capacity degradation, as illustrated in FIGS. 11B and 11C. FIG. 11B shows the voltage versus time of a battery having a 2 m ZnSO₄ electrolyte and FIG. 11C shows the voltage versus time of a battery having a 0.5 m Zn(ClO₄)₂ electrolyte. Both of these batteries exhibit a pronounced voltage degradation after a rest period of 24 h. More specifically, these two batteries, whose characteristics are illustrated in FIGS. 11B and 11C, show a columbic efficiency (CE) of about 71% after a 24 h rest period. These results verifies that the O₂ and H₂ evolutions during storage are negligible in the novel battery 800, and the dissolution and self-discharge problems of the Na₂V₆O₁₆ electrode can be resolved by the highly-concentrated electrolyte 430.

Thus, the large-scale preparation of the electrolyte and cathode material of the battery 800, the low production cost, and the high performance in rechargeable ZIBs, make the novel battery 800 a good candidate for practical and scalable production of potentially commercial ZIBs, and the safe ZIBs with high rate capability can enable their applications in sensors, electric vehicles, and wearable electronics.

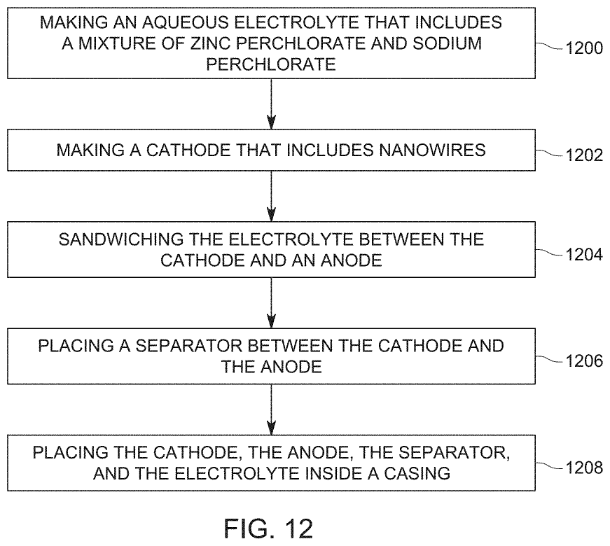

A method for making such a battery is now discussed with regard to FIG. 12. The method illustrated in FIG. 12 includes a step 1200 of making an aqueous electrolyte 430 that includes a mixture of zinc perchlorate and sodium perchlorate, a step 1202 of making a cathode 700 that includes nanowires, a step 1204 of sandwiching the electrolyte 430 between the cathode 700 and an anode 810, a step 1206 of placing a separator 820 between the cathode 700 and the anode 810, and a step 1208 of placing the cathode 700, the anode 810, the separator 820, and the electrolyte 430 inside a casing 802. A ratio of the sodium perchlorate to the zinc perchlorate is at least 30.

In one embodiment, the ratio of the sodium perchlorate to zinc perchlorate is 36. In another embodiment, the electrolyte includes 0.5 m of the zinc perchlorate and 18 m of the sodium perchlorate, and m stands for molality. In one application, the zinc perchlorate has a molality between 0.25 and 0.75 and the sodium perchlorate has a molality between 16 and 18.

In one embodiment, the step of making the cathode includes reacting V₂O₅ with NaCl to obtain the nanowires made of Na₂V₆O₁₆, mixing the Na₂V₆O₁₆ nanowires with conductive carbon and a poly binder to obtain a mixture, making a slurry by adding N-methyl-2-pyrrolidone, as a solvent, to the mixture, casting the slurry onto a titanium foil using a doctor blading method, and drying the casted slurry in a vacuum oven. The method may further include a step of making the anode to include zinc.

The disclosed embodiments provide a novel electrolyte-cathode combination that is very advantageous for a zinc ion battery. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A zinc ion battery comprising:
a cathode;
an anode;
a separator; and
an electrolyte sandwiched between the cathode and the anode,
wherein the electrolyte includes a mixture of zinc perchlorate and sodium perchlorate, and
wherein a ratio of the sodium perchlorate to zinc perchlorate is at least 30.

2. The battery of claim 1, wherein the ratio of the sodium perchlorate to zinc perchlorate is 36.

3. The battery of claim 1, wherein the electrolyte includes 0.5 m of the zinc perchlorate and 18 m of the sodium perchlorate, and m stands for molality.

4. The battery of claim 1, wherein the zinc perchlorate has a molality between 0.25 and 0.75 and the sodium perchlorate has a molality between 16 and 18.

5. The battery of claim 1, wherein the cathode is made of vanadium.

6. The battery of claim 1, wherein the cathode includes sodium, vanadium and oxygen.

7. The battery of claim 1, wherein the cathode includes nanowires made of Na₂V₆O₁₆.

8. A combination of a cathode and an electrolyte for a zinc ion battery, the combination comprising:
the cathode including nanowires; and
the electrolyte including a mixture of zinc perchlorate and sodium perchlorate,
wherein a ratio of the sodium perchlorate to the zinc perchlorate is at least 30.

9. The combination of claim 8, wherein the ratio of the sodium perchlorate to the zinc perchlorate is 36.

10. The combination of claim 8, wherein the electrolyte includes 0.5 m of the zinc perchlorate and 18 m of the sodium perchlorate, and m stands for molality.

11. The combination of claim 8, wherein the zinc perchlorate has a molality between 0.25 and 0.75 and the sodium perchlorate has a molality between 16 and 18.

12. The combination of claim 8, wherein the cathode includes vanadium.

13. The combination of claim 8, wherein the cathode includes sodium, vanadium and oxygen.

14. The combination of claim 8, wherein the cathode includes nanowires made of Na₂V₆O₁₆.

15. A method of manufacturing a zinc ion battery, the method comprising:
making an aqueous electrolyte (430) that includes a mixture of zinc perchlorate and sodium perchlorate;
making a cathode that includes nanowires;
sandwiching the electrolyte between the cathode and an anode;
placing a separator between the cathode and the anode; and
placing the cathode, the anode, the separator, and the electrolyte inside a casing,
wherein a ratio of the sodium perchlorate to the zinc perchlorate is at least 30.

16. The method of claim 15, wherein the ratio of the sodium perchlorate to the zinc perchlorate is 36.

17. The method of claim 15, wherein the electrolyte includes 0.5 m of the zinc perchlorate and 18 m of the sodium perchlorate, and m stands for molality.

18. The method of claim 15, wherein the zinc perchlorate has a molality between 0.25 and 0.75 and the sodium perchlorate has a molality between 16 and 18.

19. The method of claim 15, wherein the step of making the cathode comprises:
reacting V₂O₅ with NaCl to obtain the nanowires made of Na₂V₆O₁₆;
mixing the Na₂V₆O₁₆ nanowires with a conductive carbon and a poly binder to obtain a mixture;
making a slurry by adding N-methyl-2-pyrrolidone, as a solvent, to the mixture;
casting the slurry onto a titanium foil using a doctor blading method; and
drying the casted slurry in a vacuum oven.

20. The method of claim 15, further comprising:
making the anode to include zinc.
